(19) United States
(12) Patent Application Publication
(10) Pub. No.: US 2026/0113539 A1
(43) Pub. Date: Apr. 23, 2026

(54) EVENT-DOMAIN RAPID CONTINUOUS BRACKETING

(71) Applicant: HUAWEI TECHNOLOGIES CO., LTD., Shenzhen (CN)

(72) Inventors: Stepan Tulyakov, Zurich (CH); Dragos Andrei Chileban, Zurich (CH); Julius Erbach, Zurich (CH); Daniel Clemens Eckert, Zurich (CH); Yuanyou Li, Shenzhen (CN)

(73) Assignee: HUAWEI TECHNOLOGIES CO., LTD., Shenzhen (CN)

(21) Appl. No.: 19/397,215

(22) Filed: Nov. 21, 2025

Related U.S. Application Data
(63) Continuation of application No. PCT/EP2023/067875, filed on Jun. 29, 2023.

(51) Int. Cl. H04N 23/67; G06T 5/50; G06V 10/25; H04N 25/47

(52) U.S. Cl. CPC H04N 23/676; G06T 5/50; G06V 10/25; H04N 25/47; G06T 2207/20221

(57) ABSTRACT

An apparatus and method for event-based image bracketing are provided. The apparatus includes an image camera and an event camera. The image camera acquires one or more images with fixed camera settings. The settings of the image camera are changed rapidly and events are recorded by the event camera. The acquired one or more images and part of the bracketed events are then fused to produce a composite image. A composite image can be an image with a desired camera setting, or an image with properties that cannot be captured with the image camera regardless of settings, such as an all-in-focus image. A distance of the sharpest focus setting can also be determined from the bracketed events. The focus of the image camera can then be set to this determined distance.

### CROSS-REFERENCE TO RELATED APPLICATIONS

This application is a continuation of International Application No. PCT/EP2023/067875, filed on Jun. 29, 2023, the disclosure of which is hereby incorporated by reference in its entirety.

### FIELD

Embodiments of the present disclosure relate generally to cameras and more particularly to image bracketing.

### BACKGROUND

Image bracketing is a camera technique where multiple images of the same scene are captured with different camera settings. The different settings can include, but are not limited to, exposure, focus, aperture and zoom. Many modern cameras have a build-in image bracketing function making it easier to take multiple images as well as perform image bracketing.

There are a number of approaches to image bracketing. Typical solutions generally allow for the capture of very few images (such as 3 images) with different camera settings. However, these solutions tend to be time consuming and resource intensive. Moreover, conventional image bracketing can suffer from blur and misalignment caused by motion during the image acquisition process.

Thus, there is a need for an improved apparatus and method for image bracketing. Accordingly, it would be desirable to provide an apparatus and method that addresses at least some of the problems described above.

### SUMMARY

Embodiments of the present disclosure are directed to an apparatus and methods for image bracketing. The aspects of the disclosed embodiments leverage properties of an event camera and an image camera to address the drawbacks of conventional bracketing. One or several well-exposed anchor image(s) are acquired with fixed camera settings. Bracketed events are then captured while swiftl camera settings are changed. The camera settings are changed in what is generally referred to herein in a “rapid or fast manner.” In one embodiment, the camera settings are changed in an automated manner using specialized actuators or devices. This speed efficiency is achieved because camera settings can be changed without the need to expose images. Since events have a very high temporal resolution, the lens elements of the camera can be adjusted very rapidly, or as fast as is allowed by the corresponding hardware actuators or controls. The camera settings can include for example, but are not limited to, focus distance, aperture opening or lens magnification. In this fashion, the aspects of the disclosed embodiments produce composite images with superior properties or characteristics. For example in case of focus bracketing we can produce all-in-focus image, where all parts of the image appears sharp.

According to a first aspect, the above and further implementations and advantages are obtained by an apparatus. In one embodiment, the apparatus incudes an image camera and an event camera. A processor can communicatively coupled with the image camera and the event camera. A memory can be communicatively coupled with the processor. The memory will generally include program instructions that when executed by the processor cause the apparatus to acquire one or more images of an area of interest with the image camera and record bracketed events of the area of interest with the event camera while changing one or more settings of the camera. The acquired one or more images and at least part of the recorded bracketed events are then combined or fused to produce an image with a desired setting of the camera. Performing image bracketing based on events is more memory and energy efficient, enables faster acquisition, and the composite image(s) that is produced not degraded due to object motion during the acquisition process.

In a possible implementation form, the apparatus is configured to register a continuous change of camera settings with the event camera. The aspects of the disclosed embodiments enable continuous sampling of camera settings and probing all possible settings of the camera.

In a possible implementation form, the apparatus is configured to rapidly change the settings of the camera. The aspects of the disclosed embodiments enable the settings of the camera to be changed as quickly as the camera hardware or actuators will allow. This enables fast acquisition since only one image is captured with fixed settings of the camera and events recorded while rapidly changing the settings.

In a possible implementation form, the apparatus is configured to temporally synchronize the image camera and the event camera. The aspects of the disclosed embodiments allow for events to be captured or recorded while camera settings are changed.

In a possible implementation form, the apparatus is further configured to record bracketed events while a focus setting of the camera is changed. Images can then be fused to obtain an image with superior qualities, such as an all-in-focus image to extend the depth of field. The aspects of the disclosed embodiments enable fast acquisition since one image is captured at fixed settings and events recorded while rapidly changing the settings.

In a possible implementation form, the apparatus is further configured to determine a focusing distance and focusing frame from the recorded events. The aspects of the disclosed embodiments enable the focus distance to be determined quickly, such as for example, 5 milliseconds, while being robust to motion blur, strong light and low light.

In a possible implementation form, the determined focusing distance is used to focus a frame-based camera, such as for example, but not limited to a red-green-blue (RGB) camera. The aspects of the disclosed embodiments enable the focus distance to be determined quickly, while being robust to motion blur, strong light and low light.

In a possible implementation form, the focus setting of the camera is changed from one of a closest distance to a farthest distance or a farther distance to a closest distance. The focus setting adjustment can start from any arbitrary setting and span entire range of settings, such as closest to farthest or farthest to longest, or any suitable range therebetween.

In a possible implementation form, the change of the focus setting of the camera is arbitrary. The focus setting adjustment can start from any arbitrary setting and span entire range of settings. The aspects of the disclosed embodiments provide continuous rather than discrete bracketing.

In a possible implementation form, the focusing distance is determined by maximizing a contrast of events or event images for the area of interest. Faster focusing is provided as compared to contrast based focusing.

In a possible implementation form, the one or more images of the area of interest are acquired by the camera using different focus settings of the camera and the bracketed events are recorded while changing a focus distance of the camera. The aspects of the disclosed embodiments enable capturing events while the settings of the camera are changed or adjusted.

In a possible implementation form, the apparatus is further configured to combine the one or more images with recorded bracketed events that are focus bracketed events. This enables capturing images without focus adjustment.

In a possible implementation form, the fusion of the acquired one or more images and at least part of the bracketed events is used to control a setting of the camera. The aspects of the disclosed embodiments allow for control of the camera to produce a higher quality image.

In a possible implementation form, the image camera and the event camera comprise a hybrid sensor. The use of a hybrid sensor eliminates the need for separate devices and geometric alignment of events and images is not required.

According to a second aspect, the above and further implementations and advantages are obtained by a method. In one embodiment, method includes acquiring one or more images with a camera; changing one or more settings of the camera; record one or more bracketed events with an event camera during the change of the one or more settings; and combining the acquired one or more images with the recorded one or more bracketed events to produce an image with a desired setting of the camera. Performing image bracketing based on events is more memory and energy efficient, enables a faster acquisition process, and is not degraded due to object motion during the acquisition process.

In a possible implementation form, the method further includes recording bracketed events while a focus setting of the camera is changed. The aspects of the disclosed embodiments eliminate the need to spend time focusing the frame camera in snap photography.

In a possible implementation form, the method further includes determining a focusing distance and focusing frame from the recorded bracketed events.

In a possible implementation form, the method further includes changing the focus setting of the camera from a closest distance to a farthest distance.

In a possible implementation form, the method further includes acquiring the one or more images of the area of interest by the camera using different focus settings of the camera and recording the bracketed events while changing the focus settings of the camera. The aspects of the disclosed embodiments provide event-domain rapid continuous image bracketing with application to auto focus, re-focusing and all-in-focus imaging.

In a possible implementation form, the method further includes temporally synchronizing the image camera and the event camera. The aspects of the disclosed embodiments reduce issues due to object motion during image acquisition.

In a possible implementation form, the method further includes geometrically aligning the captured images and recorded events. The aspects of the disclosed embodiments reduce issues due to object motion during image acquisition.

In a possible implementation form, the method further includes sweeping all possible settings of the camera. The aspects of the disclosed embodiments enable starting camera setting changes from any arbitrary setting and spanning an entire range of camera settings.

In a possible implementation form, the method further includes capturing events with the event camera while sweeping all possible settings of the camera. The aspects of the disclosed embodiments enable starting camera setting changes from any arbitrary setting and spanning an entire range of camera settings.

In a possible implementation form, the method further includes producing a refocused image based on the combination of the acquired images and recorded bracketed events. The aspects of the disclosed embodiments produce composite images from images and bracketed events with properties such as All-in-Focus, that cannot be realized with conventional image bracketing In a possible implementation form, the method further includes producing an all-in-focus image based on the combination of the acquired images and recorded bracketed events. The aspects of the disclosed embodiments enable computing an all-in-focus image when it is not possible to directly acquire the image due to a limited depth of field of the camera.

According to a third aspect, the above and further implementations and advantages are obtained by a computer program product including non-transitory computer program instructions that when executed by a processor are configured to cause the processor to perform the method according to any one of the possible implementation forms.

According to a fourth aspect, the above and further implementations and advantages are obtained by an apparatus. In one embodiment, the apparatus incudes an image camera and an event camera. A processor can be communicatively coupled with the image camera and the event camera. A memory can be communicatively coupled with the processor. The memory will generally include program instructions that when executed by the processor cause the apparatus to record bracketed events of an area of interest with the event camera while changing one or more settings of the camera. A distance of the sharpest focus is computed from the bracketed events and the focus of the image camera can be set to that distance. Performing image bracketing based on events is more memory and energy efficient, enables faster acquisition, and the composite image(s) that is produced not degraded due to object motion during the acquisition process.

These and other aspects, implementation forms, and advantages of the embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which like references indicate like elements and:

FIG. 1 illustrates a block diagram of an apparatus according to an embodiment of the present disclosure.

FIG. 2 illustrates a block diagram of an apparatus.

FIG. 3 illustrates a flow chart depicting a method for event image bracketing according to an embodiment of the present disclosure.

FIG. 4 illustrates a flow chart depicting a process flow for event image bracketing according to an embodiment of the present disclosure.

FIG. 5 illustrates a process flow for event image bracketing according to an embodiment of the present disclosure

FIG. 6 illustrates a process flow for event image bracketing according to an embodiment of the present disclosure.

FIG. 7 illustrates a process flow for event image bracketing according to an embodiment of the present disclosure.

FIG. 8 illustrates a process flow for event image bracketing according to an embodiment of the present disclosure.

### DETAILED DESCRIPTION OF THE DISCLOSED EMBODIMENTS

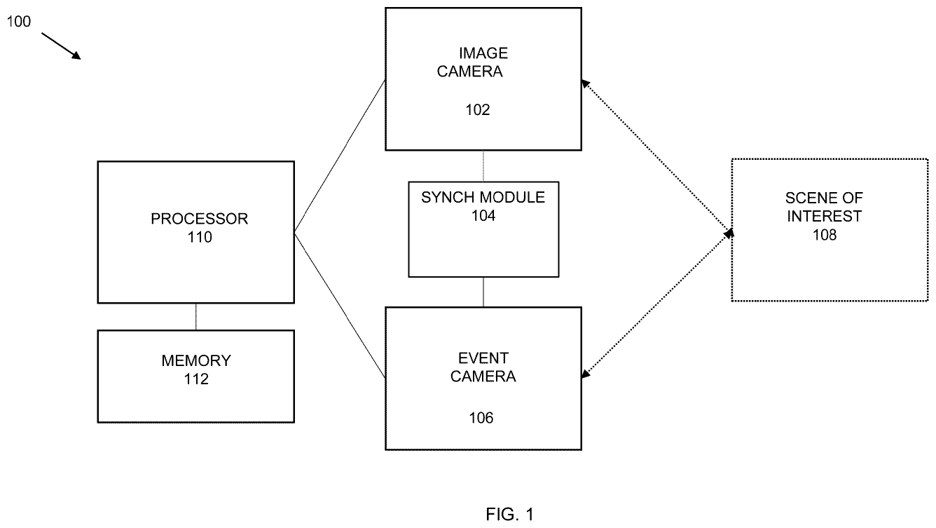

FIG. 1 illustrates a block diagram of an apparatus 100 configured for event-domain image bracketing incorporating aspects of the disclosed embodiments. As shown on the example of FIG. 1, in one embodiment, the apparatus 100 generally comprises a camera 102 and an event camera 106. The camera 102 can also be referred to or understood as an “image” camera or a “frame” based camera.

The image camera 102 is generally configured to acquire one or several image(s) of a scene of interest 108 with fixed camera settings. In one embodiment, the image camera 102 is a red-green-blue (RGB) type camera. In alternate embodiments, any suitable camera or sensor can be utilized for the image camera 102, including for example, but not limited to, a Gray pattern camera or other Bayer pattern camera

The event camera 106 is configured to record bracketed events while the settings of the image camera 102 are adjusted or changed. The event camera 106 generally comprises an imaging sensor that responds to local changes in scene brightness. The event camera 106 can also be referred to as, or comprise, a neuromorphic camera, a silicon retina sensor, or a dynamic vision sensor. Generally, the aspects of the disclosed embodiments are not intended to be limited by the specific type of event camera.

Generally, each pixel of the event 106 camera operates independently and asynchronously. Events are generated when a change in brightness occurs. The event camera 106 is configured to asynchronously measure per-pixel brightness changes and output a stream of events that encode the time, location and sign of the brightness changes. In one embodiment, the event camera 106 of the disclosed embodiments can comprise a high temporal resolution camera. The use of a high temporal resolution event camera 106 allows recording a continuous space of images with all intermediate camera settings in a very short time interval in the form of bracketed events. The event representation is highly compressed and requires less memory than the memory required for storage of images. In alternate embodiments, the event camera 106 can comprise any suitable type of event camera.

The event camera 106 of the disclosed embodiments generally has low power requirements, allowing the aspects of the disclosed embodiments to be very energy efficient. Additionally, because the acquisition time of the event camera 106 is short, events do not suffer from motion blur. Thus, the problems due to motion during image acquisition is largely avoided.

In one embodiment, the apparatus 100 is configured to combine or “fuse” the acquired one or more images and at least part of the recorded bracketed events. The fusion is generally configured to produce an image with a desired setting of the camera 102. Alternatively, an image is produced with properties that cannot be captured with the image camera 102 regardless of settings, such as an All-in-Focus image. Additionally, the fusion process can be used to further control the image camera 102, such as by changing a focus of the image camera 102.

The aspects of the disclosed embodiments also enable controlling settings of the image camera 102, such as the camera focus. For example, in one embodiment, the aspects of the disclosed embodiments enable computing a distance of a sharpest focus from the bracketed events. The focus of the image camera 102 can then be set to this computed distance, either manually or automatically.

In one embodiment, the apparatus 100 includes a processor 110 and a memory 112. The processor 110 is generally communicatively coupled with the memory 112. The memory 112 will generally include, among other things, program instructions that when executed by the processor 110 cause the apparatus 100 to acquire the one or more images of the area of interest with the image camera 102. The acquired images, which may also be referred to as “anchor images”, are generally well-exposed or good quality images. While one or more images are generally referred to herein, the aspects of the disclosed embodiments allow image bracketing functionalities with a single captured image.

Generally, the one or more images are captured while the settings of the image camera 102 are fixed. At the time at which the image is captured, the optics of the image camera 102 and the event camera 106 can be set to the same settings. For example, for focus bracketing, the same focus point setting and depth of field setting are used.

The aspects of the disclosed embodiments allow for events to be captured by the event camera 106 before or after the image is acquired by the image camera 102. While events are being captured by the event camera 106, camera settings such as for example, but not limited to, the focus, focal length or aperture, are rapidly changed. Depending upon the type of lens or optics, the speed of changing the camera setting can be on the order of milliseconds, such as for example, but not limited to, 5 milliseconds. The speed or rapidity of changing or adjusting the settings of the camera 102 is generally only limited by the ability, or capabilities, of the actuator hardware of the camera 102 used to control and adjust the camera settings.

In one embodiment, using the event camera 106, the apparatus 100 is configured to record events, also referred to herein as “bracketed events”, of the area of interest 110, while one or more settings of the image camera 102 are changed. The aspects of the disclosed embodiments enable a continuous sampling of camera settings while recording events with the event camera 106. The aspects of the disclosed embodiments enable probing all possible settings of the camera, starting from any arbitrary setting for example, and spanning an entire or other suitable range of settings of the camera.

The image camera 102 and the event camera 106 are generally positioned in a manner so as to be able to capture images and events, respectively, from or of, the scene of interest 108. In alternate embodiments, the image camera 102 and the event camera 106 can be positioned in any suitable manner, including for example, but not limited to, side-by-side, a stereo configuration, a configuration with a beam splitter or implemented as a single hybrid sensor, as will be further described below.

Referring still to FIG. 1, in one embodiment, the image camera 102 and the event camera 106 can be temporally and geometrically synchronized and aligned. In the example of FIG. 1, a synchronization block or module 104 can be used to temporally synchronize the image camera 102 and the event camera 106. In alternate embodiments, the image camera 102 and the event camera 106 can be temporally and geometrically synchronized in any suitable manner.

Although the example of FIG. 1 illustrates a separate synchronization block or module 104, the aspects of the disclosed embodiments are not so limited. In alternate embodiments, the synchronization and/or geometric alignment of the image camera 102 and the event camera 106 can be achieved in any suitable manner. For example, one or more of the image camera 102 or the event camera 106 can include or incorporate the synchronization module 104.

The image camera 102 and the event camera 106 can also comprise a “frame-based” sensor and an “event-based” sensor. Such sensors will have similar fields of view and have temporal synchronization. In some implementations, the image camera 102 and the event camera 106 will have similar optics.

In one embodiment, a liquid lens is implemented in one or more of the image camera 102 and the event camera 106. The use of an adjustable liquid lens can enable a rapid focus adjustment, such as for example, approximately 5 milliseconds.

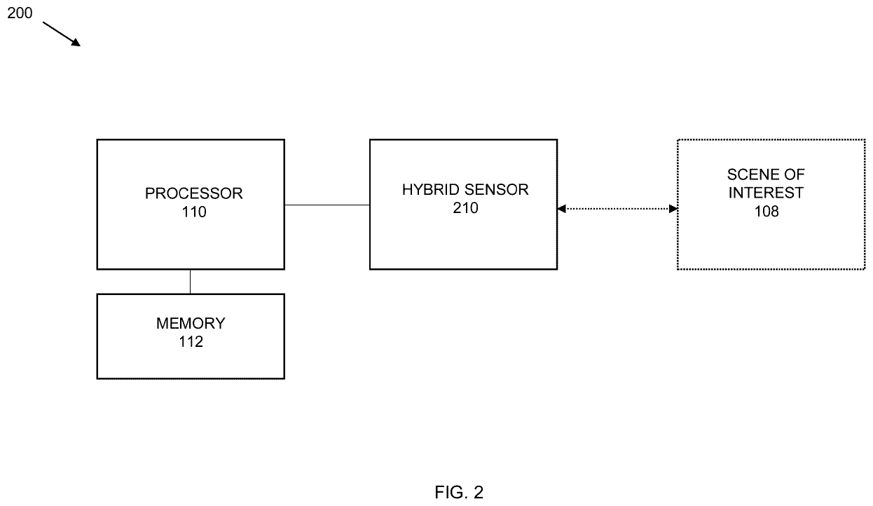

FIG. 2 illustrates a block diagram of an apparatus 200 incorporating aspects of the disclosed embodiments. In this example, one or more of the image camera 102 and the event camera 106 are replaced with or implemented as a hybrid sensor 210. A hybrid sensor generally implements event pixels and normal RGB pixels on one silicon device. This eliminates the needs for separate devices for the image camera 102 and the event camera 106. One of the main benefits of use of a hybrid sensor in conjunction with the aspects of the disclosed embodiments is that geometric alignment of events and images is not required.

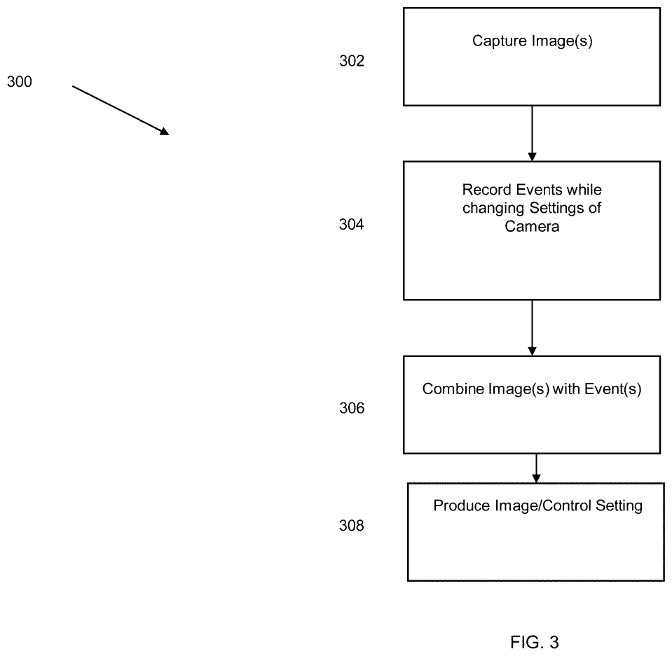

FIG. 3 illustrates on example of a process 300 incorporating aspects of the disclosed embodiments. In one embodiment, one or more images are acquired or captured 302. The captured images, also referred to herein as “anchor images” are generally well exposed, or good quality images. In one embodiment, the image(s) acquired by the image camera 102 of FIG. 1 are acquired with fixed camera settings. The camera settings generally include, but are not limited to, focus distance, aperture opening or lens magnification.

The process 300 then includes recording events 304, also referred to as “bracketed events” herein, with the event camera 106 of FIG. 1, while the settings of the image camera 102 are changed. Changing 304 the settings of the image camera 102 can include a sweep of the settings of the image camera 102. In one embodiment, changing 304 the settings can involve a sweep of the camera settings without any intermediate stops. The aspects of the disclosed embodiments enable a probe of all possible settings of the image camera 102 in a very short time interval. The time interval can be as fast as allowed by the lens actuator. Generally, the captured images and recorded events are temporally synchronized and geometrically aligned.

In one embodiment, the acquired image(s) and bracketed event(s) are combined or fused 306. In one embodiment, the method 300 includes fusing 306 the acquired image and at least part of the bracketed events that describe changes from the acquired image to the latent image with the desired camera settings. For example, in one embodiment, from all of the recorded events, only events triggered when the lens was changing focus from the setting corresponding to acquired image to the setting corresponding to latent image, are captured. In an alternate embodiment, all bracketed events are used.

In one embodiment, the fusing 306 can produce 308 an image with the desired camera setting. The desired camera setting(s) can include for example, but are not limited to, focus, aperture opening, or zoom. The produced image 308 can also be referred to as a composite image. In an alternate embodiment, the fusing 306 can produce an image that has properties that cannot be captured with the image camera 102, such as an All-in-Focus image. In a further embodiment, the fusing 306 can be used to control settings of the image camera 102, such as camera focus.

These composite image(s) will generally have properties that are superior to the original camera settings. For example, in the case of focus bracketing, an all-in-focus image is produced where all parts of the image appear sharp.

### Auto Focus Using Focus Bracketed Events

The aspects of the disclosed embodiments enable finding an optimal focusing distance using a bracketed event stack. The image camera 102, such as a RGB camera, can then be focused accordingly using the optimal focusing distance setting. The optimal focusing distance can be determined in as quickly as approximately five (5) milliseconds when a liquid lens is used on the image camera 102. Although a time frame of approximately five (5) milliseconds is generally referred to herein, the aspects of the disclosed embodiments are not so limited. In alternate embodiments, the time frame can be any suitable time frame other than including five (5) milliseconds.

Typical Auto Focus methods generally include Contrast Detection Auto Focus (CDAF) and Phase Detection Auto Focus (PDAF). These methods capture focus-bracketed images and then find the image with the best contrast in the area of interest. However, every image has to be properly exposed and blur free. Typical Contrast Detection Auto Focus is generally slow and cannot handle fast moving objects. Phase Detection Auto Focus (PDAF) tends not to work well under challenging lighting conditions, such as strong or low light.

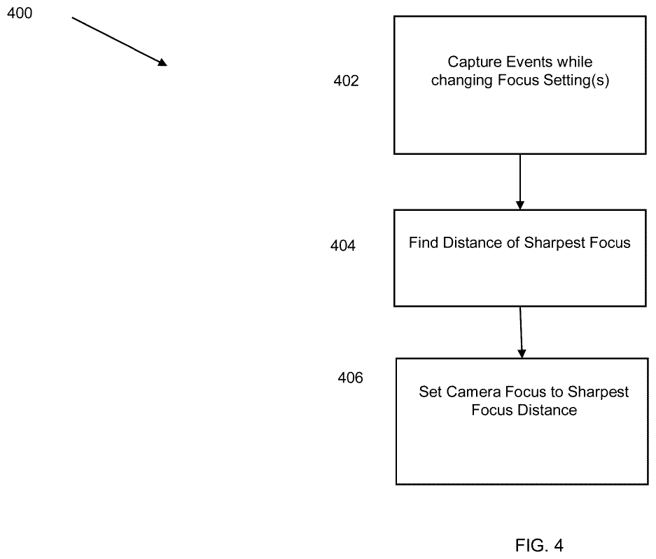

By focusing the camera 102 based on contrast detection in focus-bracketed events, the aspects of the aspects of the disclosed embodiments can provide Auto Focus with Event Bracketing or Focus Bracketed Events. Referring to FIG. 4, one embodiment of a process flow 400 for Auto Focus with Focus Bracketed Events is illustrated. The aspects of the disclosed embodiments enable determining a distance of a sharpest focus from bracketed events and then setting or physically refocusing the image camera 102 to this distance.

As illustrated in FIG. 4, the event camera 106 captures one or more bracketed events 402, referred to herein as “focus bracketed events”, while one or more focus settings of the image camera 102 are changed as is described above. As an illustrative, non-limiting example, focus bracketed events can be captured by the event camera 106 while refocusing the image camera 102 from one or more of a closest distance to a farthest distance or a farthest distance to a closest distance, or any range therebetween. In alternative embodiments, the focus settings change can start at any desired or arbitrary setting and span an entire range of settings, other than including closest to farthest or farthest to closest.

The distance of the sharpest focus is then determined or computed 404 from the bracketed events. For example, the aspects of the disclosed embodiments can discretise events into event images and find the event image with a maximum contrast. The focus frame of the image camera 102, or RGB camera, can be set or adjusted 406 to this distance to provide the refocused image.

In one embodiment, the optimal focusing distance is determined or computed by maximizing a contrast of the event slices for the area of interest 108. In contrast to other methods, the method of the disclosed embodiments provides faster focusing as compared to contrast based focusing. The method of the disclosed embodiments is also robust to object motion, and works well under difficult lighting conditions, such as strong and low light, due to the high temporal resolution and high dynamic range of the event camera 106.

### Refocusing with Focus-Bracketed Events

Existing depth and image segmentation-based refocusing generally depends on the quality of the depth sensor. The refocusing result generally does not allow for recovering blurred areas.

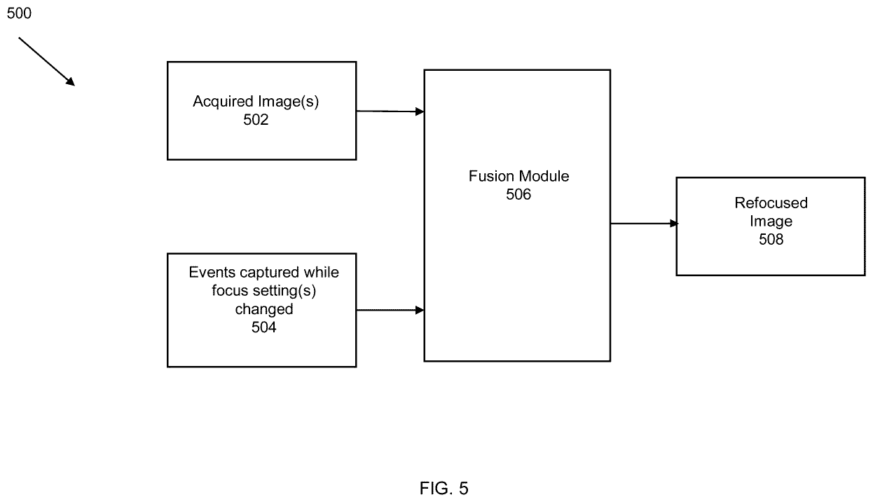

Referring to FIG. 5, the aspects of the disclosed embodiments enable Refocusing with Focus-Bracketed Events using a single acquired image and focus-bracketed events. The aspects of the disclosed embodiments enable “digital” refocusing by fusing events and an image with another focus.

As illustrated in the process flow of FIG. 5, acquired images 502 are an input to the fusion module 506. The acquired images 502 include images captured by the image camera 102 of FIG. 1. In one embodiment, the acquired images 502 include images that are acquired by the image camera 102 with different focuses.

The bracketed events 504 in this example are events that are recorded or captured by the event camera 106 of FIG. 1 while rapidly changing a focusing distance of the image camera 102. This can include for example, events captured while the focus is changing from closest to farthest, farther to closest, or any range therebetween, passing through all possible settings. The bracketed events 504 in this example describe the transformation from the acquired image to the latent image with the desired focus. In one embodiment, the event inputs 504 include only those events that were triggered when the lens of the image camera 102 was changing focus from a setting corresponding to the acquired image to a setting corresponding to the latent image.

The fusion module or algorithm 506 in this example is used to process the acquired image(s) 502 and captured events input 504 to produce a composite image 508 with the desired focus, also referred to as a “refocused image.” In one embodiment, motion during event bracket acquisition is handled by performing rudimentary event-based image interpolation.

In one embodiment, the fusion module 506 can comprise or include a neural network architecture that can be used to produce the refocused image 508. One example of a neural network architecture is “UNET.” In alternate embodiments, any suitable neural network architecture can be used.

Unlike traditional refocusing methods, the aspects of the disclosed embodiments produce authentic refocusing without the need for depth and image segmentation and allows recovering areas that are blurred on the anchor image. The rapid continuous event bracketing of the disclosed embodiments provides advantages such as less memory usage, energy efficiency and high speed. The aspects of the disclosed embodiments can enable capturing images without focusing, which is especially important in time-sensitive snap photography.

### All-In-Focus with Focus-Bracketed Events

Existing focus stacking methods require multiple images with different focuses. These methods tend to be slow, energy and memory inefficient, and suffer from motion blur and misalignment due to the motion during image acquisition.

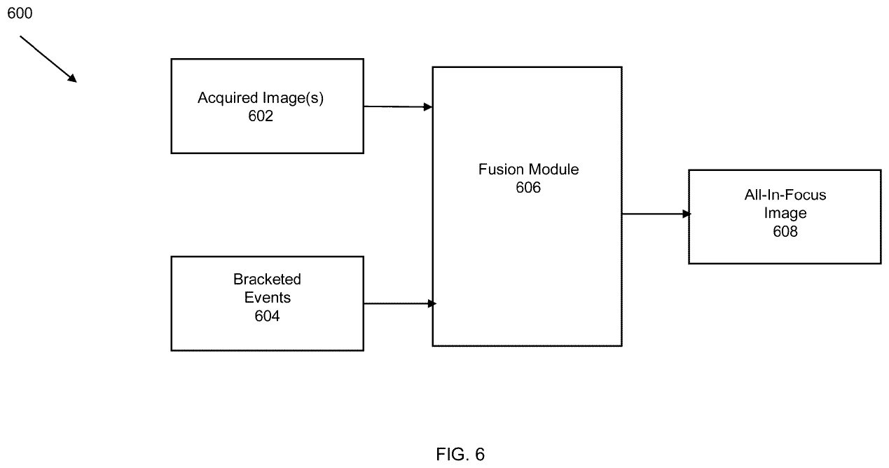

Referring to FIG. 6, the aspects of the disclosed embodiments enable All-in-Focus with Focus-Bracketed Events from a single captured or acquired image input 602 and all focus bracketed events 604. In one embodiment, the process flow 600 fuses the acquired image(s) input 602 and the bracketed events input 604 using a fusion algorithm 606. The result 608 is an all-in-focus image.

In the example of FIG. 6, the bracketed events input 604 includes all focus bracketed events recorded by the event camera 106. This is different from the example of FIG. 5, where the events that are recorded are only those events detected while the focus is changing from the focus of the input image to the desired focus.

The method of the disclosed embodiments allows computing all-in-focus image in the situations when it is impossible to directly acquire the image due to a limited Depth-of-Field of the camera 102. This finds particular application in situations such as macro or landscape photography.

### Geometric Fusion of Events and Images

Direct fusion of event brackets and anchor images for image refocusing and all-in-focus imaging does not provide good results when the event data is sparse due to limited contrast sensitivity of an event sensor. To address this problem, the aspects of the disclosed embodiments can use geometric fusion for refocusing and all-in-focus imaging. Instead of directly predicting pixel intensities, the aspects of the disclosed embodiments apply a geometric approach and predict per-pixel blur/de-blur kernel, and apply the predicted per-pixel kernel to the original image.

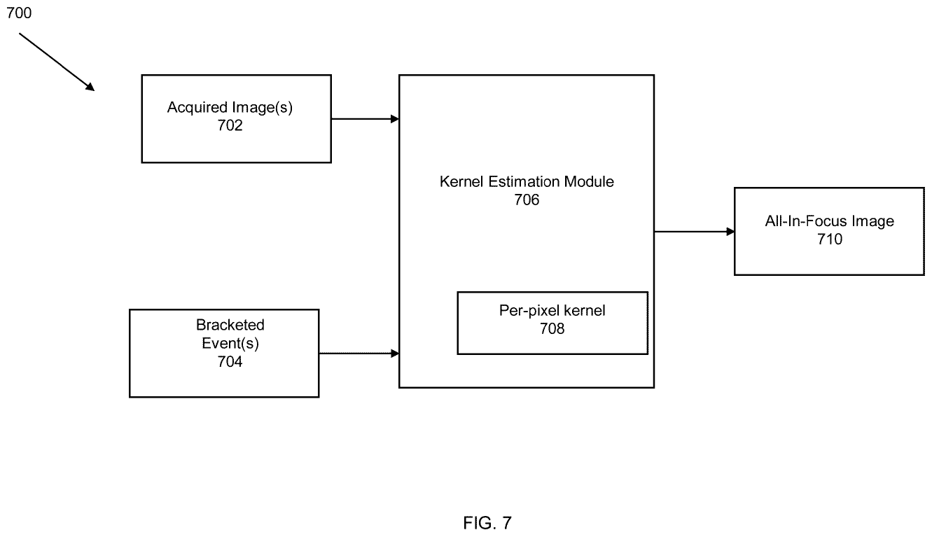

Referring to FIG. 7, in one embodiment, the process flow 700 takes the acquired image(s) 702 input and all events captured while the focus settings are changed input 704 and estimates a per-pixel blur or pseudo de-blur kernel 708. This kernel 708 is applied to the input image 702 to produce an All-In-Focus image 710. The process 700 takes advantage of the fact that blur / de-blur kernel can be densely estimated from the sparse events.

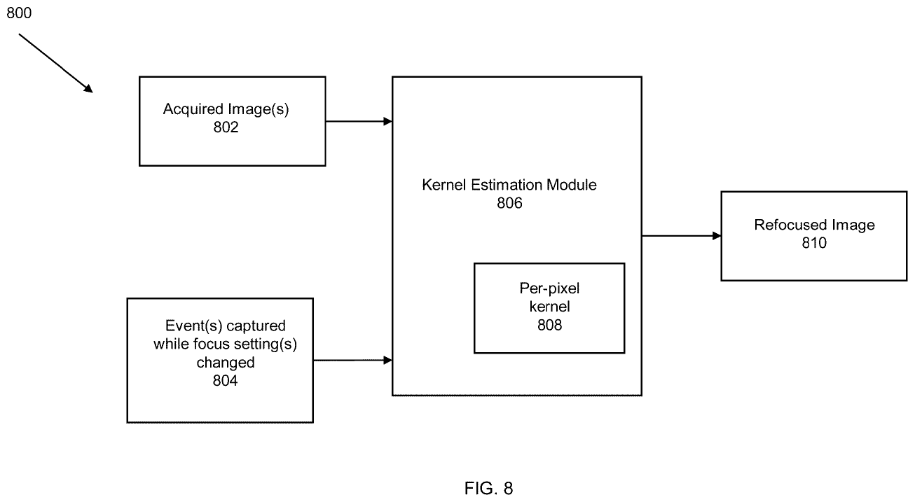

FIG. 8 is similar to FIG. 7 except that the event input 804 is different. In this example, similar to FIG. 4, the recorded event input 804 includes only those events recorded while the focus of the image camera 102 is changing from the focus of the input image to the desired focus. For example, the event input 804 can include all events captured while the focus of the imaging camera 102 is changing from closest to farthest, passing through all possible settings. A per-pixel blur or pseudo de-blur kernel is estimated 808 and is applied to the input image 802 to produce a refocused image 810.

The aspects of the disclosed embodiments acquire or capture one or several images with fixed camera settings. Bracketed events are then recorded by an event camera while rapidly changing settings of the camera without intermediate stops. The event representation is highly compressed and requires less memory that images. By fusing the acquired image(s) with bracketed events, the event imaging bracketing of the disclosed embodiments provides advantages such as better memory and energy efficiency, a fast image acquisition process, continuous rather than discrete bracketing and less issues due to object motion during the acquisition process.

Auto Focus with Focus Bracketed Events does not require capturing and fusing images with events. It simply computes distance of the sharpest focus from the bracketed events and then sets the focus of the frame-based camera to this distance.

Thus, while there have been shown, described, and pointed out, fundamental novel features of the invention as applied to the embodiments thereof, it will be understood that various omissions, substitutions and changes in the form and details of apparatuses and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus comprising an image camera, an event camera and a processor communicatively coupled with a memory, wherein the memory comprises program instructions that upon being executed by the processor cause the apparatus to:
acquire one or more images of an area of interest with the image camera;
record bracketed events of the area of interest with the event camera while changing one or more settings of the image camera; and
combine the acquired one or more images and at least part of the recorded bracketed events to produce an image with a desired setting of the image camera.

2. The apparatus according to claim 1, wherein the processor is further configured to execute the instructions to cause the apparatus to: register a continuous change of camera settings with the event camera.

3. The apparatus according to claim 1, wherein the processor is further configured to execute the instructions to cause the apparatus to: temporally synchronize the image camera and the event camera.

4. The apparatus according to claim 1, wherein the processor is further configured to execute the instructions to cause the apparatus to: record the bracketed events while a focus setting of the image camera is changed.

5. The apparatus according to claim 1, wherein the processor is further configured to execute the instructions to cause the apparatus to: determine one or more of a focusing distance and a focusing frame for the image camera from the recorded bracketed events.

6. The apparatus according to claim 1, wherein the focus setting of the image camera is changed from one of a closest distance to a farthest distance or the farther distance to the closest distance.

7. The apparatus according to claim 1, wherein the change of the focus setting of the image camera is arbitrary.

8. The apparatus according to claim 1, wherein the focusing distance is determined by maximizing a contrast for the area of interest.

9. The apparatus according to claim 1, wherein the one or more images of the area of interest are acquired by the image camera using different focus settings of the image camera and the bracketed events are recorded while changing a focus distance of the image camera.

10. The apparatus according to claim 1, wherein the processor is further configured to execute the instructions to cause the apparatus to: combine the one or more images with the recorded bracketed events that are focus bracketed events.

11. A method applied to an apparatus comprising an image camera, an event camera and a processor communicatively coupled with a memory, the method comprising:
acquiring one or more images with the image camera;
recording one or more bracketed events with the event camera while changing one or more settings of the image camera; and
combining the acquired one or more images with the recorded one or more bracketed events to produce an image with a desired setting of the image camera.

12. The method according to claim 9, further comprising recording the one or more bracketed events while focus settings of the image camera are changed.

13. The method according to claim 11, wherein the focus settings of the image camera are changed from one of a closest distance to a farthest distance or the farthest distance to the closest distance.

14. The method according to claim 11, wherein the one or more images of the area of interest are acquired by the image camera using different focus settings of the image camera and the one or more bracketed events are recorded while changing a focus distance of the image camera.

15. A non-transitory computer-readable medium comprising non-transitory computer program instructions that upon being executed by a processor, cause the processor to perform a method including:
acquiring one or more images of an area of interest with an image camera;
recording bracketed events of the area of interest with an event camera while changing one or more settings of the image camera; and
combining the acquired one or more images and at least part of the recorded bracketed events to produce an image with a desired setting of the image camera.

16. The non-transitory computer-readable medium according to claim 15, wherein the method further includes registering a continuous change of camera settings with the event camera.

17. The non-transitory computer-readable medium according to claim 15, wherein the method further includes temporally synchronizing the image camera and the event camera.

18. The non-transitory computer-readable medium according to claim 15, wherein the method further includes recording the bracketed events while a focus setting of the image camera is changed.

19. The non-transitory computer-readable medium according to claim 15, wherein the method further includes determining one or more of a focusing distance and a focusing frame for the image camera from the recorded bracketed events.

20. The non-transitory computer-readable medium according to claim 15, wherein the focus setting of the image camera is changed from one of a closest distance to a farthest distance or the farther distance to the closest distance.
